(19) United States
(12) Patent Application Publication
(10) Pub. No.: US 2003/0236743 A1
(43) Pub. Date: Dec. 25, 2003

(54) Electronic cash sharing system and method thereof

(76) Inventor: Moon Ki Min, Seoul (KR)

Correspondence Address: BIRCH STEWART KOLASCH & BIRCH, PO BOX 747, FALLS CHURCH, VA, 22040-0747, US

(21) Appl. No.: 10/326,999

(22) Filed: Dec. 24, 2002

(30) Foreign Application Priority Data
Jun. 25, 2002 (KR) 2002-35729

(51) Int. Cl. G06F 17/60

(52) U.S. Cl. 705/39

(57) ABSTRACT

It is disclosed that there is an electronic cash sharing system and a method thereof that are adaptive for settling an account with an electronic cash at various member shops by sharing the member shops with electronic cash issuing companies.

An electronic cash sharing system according to the present invention includes an issuing group having at least two issuing companies that issue electronic cashes; a routing server located between the issuing group and the terminal of the user for being stored with location information of the issuing companies of the issuing group; and a plurality of member shops for selling goods over the Internet.

### BACKGROUND OF THE INVENTION

1. Field of the Invention

The present invention relates to an electronic cash sharing system and a method thereof, and more particularly to an electronic cash sharing system and a method thereof that are adaptive for settling an account with an electronic cash at various member shops by sharing the member shops with electronic cash issuing companies.

2. Description of the Related Art

Recently, owing to the spread of the Internet and the improvement of telecommunication technology, electronic commerce, i.e., transactions being made over the Internet for buying goods, is briskly conducted. When goods are purchased through the Internet, credit cards and electronic cash etc are mainly used. The electronic cash tends to gain popularity among them owing to its convenience in use. However, electronic cash issuing companies are each collecting members and member shops individually at the present time so that the electronic cash cannot be shared other electronic cash issuing companies.

FIG. 1 is a block diagram representing a commodity purchasing system in use of a conventional electronic cash.

Referring to FIG. 1, the commodity purchasing system in use of the conventional electronic cash includes a user 2, a first member shop 4 and an issuing company 6. The user 2 registers for membership with the issuing company 6. The issuing company 6 has a plurality of first member shops 4 so that an electronic cash “A” it issued can be used in the Internet. The user 2 to whom the electronic cash “A” is issued from the issuing company 6 can purchase specified goods at the first member shops 4 in use of the electronic cash “A”.

To described this in more detail, firstly the user 2 registers for membership with the issuing company 6, and at the same time, is given the issued electronic cash “A”. At this moment, the user 2 loads the electronic cash “A” by sending a specified amount of money to the issuing company 6. Then, the user 2 makes connection with the first member shop 4 to purchase with the electronic cash “A” the goods he desires among the goods offered by the member shops 4. The member shop 4 makes connection with the issuing company 6 to get an approval for the amount of electronic cash “A” the user 2 want to pay when the user 2 purchases goods with the electronic cash “A”.

However, in the commodity purchasing system in use of the conventional electronic cash, the user cannot purchase goods with the electronic cash “A” at a second member shop 8 which does not register with the issuing company 6. In other words, when the second member shop 8 registers as a member shop of an electronic cash “B”, the user 2 of the electronic cash “A” cannot purchase goods with the electronic cash “A” at the second member shop 8. Besides, the user 2 cannot purchase goods with his own electronic cash at the second member shop 8 if its issuing company is different even though the second member shop 8 is the member shop of the electronic cash “A”.

In addition, end-to-end connection has not been supported between the user 2 and the issuing company 6 in the prior art. In other words, because the user 2 and the issuing company 6 have been connected through the member shop 4 etc, the end-to-end connection has not been guaranteed, thus there has been a limit in the reliability assurance between the user 2 and the issuing company 6.

### SUMMARY OF THE INVENTION

Accordingly, it is an object of the present invention to provide an electronic cash sharing system and a method thereof that are adaptive for settling an account with an electronic cash at various member shops by sharing the member shops with electronic cash issuing companies.

In order to achieve these and other objects of the invention, an electronic cash sharing system connected to the Internet through a terminal of a user for purchasing goods on the Internet in use of a specific electronic cash according to an aspect of the present invention, the electronic cash sharing system includes an issuing group having at least two issuing companies that issue electronic cashes; a routing server located between the issuing group and the terminal of the user for being stored with location information of the issuing companies of the issuing group; and a plurality of member shops for selling goods over the Internet.

If goods are purchased from the member shop in use of the specific electronic cash, the user's terminal finds in the routing server the location of an issuing company that issued the specific electronic cash, makes connection with the corresponding issuing company and requests an approval for the purchase of the goods.

The electronic cash sharing system further includes an accounts settling server installed between the member shop and the issuing group for transmitting an account settling request for the purchase of the goods to the issuing company that issued the specific electronic cash used in the member shop among the issuing companies in the issuing group.

The electronic cashes issued from all issuing companies in the issuing group are used in the member shop.

The routing server is stored with the information of the users which is transmitted from all the issuing companies in the issuing group and encrypted, and providing the location of the issuing company when connected to the user's terminal in use of the user's information.

The routing server updates the location information if there is any change in the location information.

The location information includes IP (Internet Protocol) address and URL (Uniform Resource Locator).

A method of sharing electronic cash in sharing system including an issuing group having at least two issuing companies that issue electronic cashes, a routing server connected to the issuing companies over the Internet, and a plurality of member shops selling goods over the Internet, according to another aspect of the present invention, the method includes steps of issuing a specific electronic cash when a user registers for membership with at least one issuing company among the issuing companies in the issuing group; loading the specific electronic cash by remitting a specific amount of money to the issuing company from which the specific electronic cash is issued; purchasing goods at the member shop in use of the specific electronic cash; inputting a transaction information with respect to a transaction data transmitted from the member shop; being connected to the routing server in order to confirm the location of the issuing company which issued the specific electronic cash; being connected with the issuing company whose location is confirmed and getting approved for the transaction data; and transmitting the information approved by the issuing company to the member shop and completing the purchase of the goods.

The method further comprising steps of requesting account settlement for a sales amount made in the electronic cash from the member shop to an accounts settling server; transmitting the account settlement information from the accounts settling server to the issuing company that issued the electronic cash; settling the account for the amount of money in accordance with the account settlement information and transmitting an account settlement information from the issuing company to the accounts settling server; and transmitting a message that notifies the completion of the account settlement in use of the account settlement information from the accounts settling server to the member shop.

Herein, the routing server updates the location information if there is any change in the location information.

Herein, the location information includes IP (Internet Protocol) address and URL (Uniform Resource Locator).

A method of sharing electronic cash in sharing system including a plurality of issuing companies that issue electronic cashes, a routing server connected to the issuing companies over the Internet, and a plurality of member shops selling goods over the Internet, according to still another aspect of the present invention, the method includes steps of storing location information of the issuing companies at the routing server; issuing electronic cashes different from one another, to a plurality of users; requesting for a purchase of goods at a member shop in use of any one of the electronic cashes issued from the issuing companies; getting a transaction approval for the purchase of goods from the issuing company which have issued the electronic cash after the location information of the issuing companies is confirmed; and completing the request for the purchase of goods by receiving the transaction approval information and transmitting it to the member shop.

Herein, in order to get the electronic cash, a user makes connection to any one of the issuing companies in use of the location information stored at the routing sever and has the electronic cash issued to oneself from the issuing company.

Herein, the user loads the electronic cash by remitting a specific amount of money to the issuing company from which the electronic cash is issued.

Herein, the user makes connection directly with the member shop in use of one's own terminal to request for a purchase of goods, receives into one's own terminal the transaction approval information corresponding to the request for the purchase of goods, gets an approval for the received transaction approval information from the issuing company, and then transmits the transaction approval information back to the member shop.

Herein, after the request for the purchase of goods is completed, the member shop requests an amount of money equivalent to the purchase of goods from the issuing company of the electronic cash, then the issuing company transfers the requested amount of money to the member shop.

Herein, the routing server updates the location information if there is any change in the location information.

Herein, the location information includes IP (Internet Protocol) address and URL (Uniform Resource Locator).

### BRIEF DESCRIPTION OF THE DRAWINGS

These and other objects of the invention will be apparent from the following detailed description of the embodiments of the present invention with reference to the accompanying drawings, in which:

FIG. 1 is a block diagram representing a commodity purchasing system in use of a conventional electronic cash;

FIG. 2 is a block diagram representing an electronic cash sharing system according to an embodiment of the present invention;

FIG. 3 is a flow chart representing a process of registering with an issuing company according to an embodiment of the present invention;

FIG. 4 is a flow chart representing a process of a user's purchasing goods according to an embodiment of the present invention;

FIG. 5 is a flow chart representing processes of loading electronic cash and transmitting transaction information according to an embodiment of the present invention; and

FIG. 6 is a flow chart representing a process of settling an account according to an embodiment of the present invention.

### DETAILED DESCRIPTION OF THE PREFERRED EMBODIMENT

Reference will now be made in detail to the preferred embodiments of the present invention, examples of which are illustrated in the accompanying drawings.

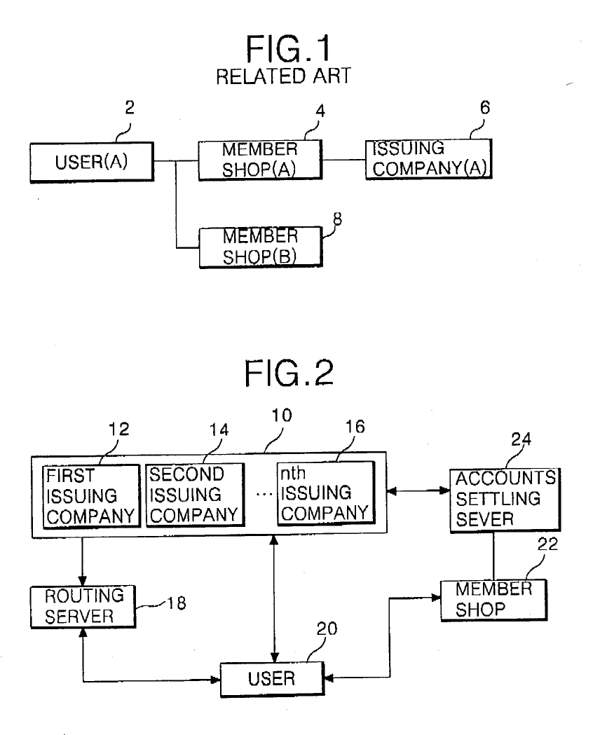

FIG. 2 illustrates an electronic cash sharing system according to an embodiment of the present invention.

Referring to FIG. 2, an electronic cash sharing system according to the present invention comprises an issuing group 10, a routing server 18, a user 20, a member shop 22 and an accounts settling server 24, wherein these are connected through telecommunication system, e.g., Internet.

The issuing group 10 includes issuing companies 12, 14 and 16 which issue various electronic cashes. For example, the issuing group 10 includes a first issuing company 12 issuing an electronic cash “A”, a second issuing company 14 issuing an electronic cash “B”, and an n^{th} (n is an integer which is three or more) issuing company 16 issuing an electronic cash “C”.

The user 20 uses at least one type of electronic cash among the electronic cashes issued by the issuing companies 12, 14 and 16 that belong to the issuing group 10.

The routing server 18 is located between the user 20 and the issuing group 10 and stored with information on the location, e.g., IP (Internet Protocol) address and URL (Uniform Resource Locator) etc., of the issuing companies 12, 14 and 16 of the issuing group 10. Also, the routing server 10 is stored with the information of the users 20, e.g., name, ID number, password and address etc, that registered for membership with any one of the issuing companies 12, 14 and 16. Herein, the information of the users 20 is encrypted and stored at the routing server 18. Accordingly, it is possible to prevent the information of the users 20 stored at the routing server 18 from being exploited for a malicious purpose.

On the other hand, the routing server 18 is installed independently, thus the users 20 can be provided with the accurate locations of the issuing companies 12, 14 and 16 by only changing the location information stored at the routing server 18. In other words, if the location information of the issuing companies 12, 14 and 16 is stored at the terminals of the users 20, the location information stored at the terminals of all users 20 must be changed when there is a change in the locations of the issuing companies 12, 14 and 16, thus it is difficult to know the exact locations of the issuing companies 12, 14 and 16 in real time as well as it takes a lot of time to update all changes made.

However, the invention makes it possible for the users 20 to get the information on the exact locations of the issuing companies 12, 14 and 16 by just changing the location information of the routing server 18.

The account settling server 24 transmits account settling information sent from the member shop 22, to the issuing companies 12, 14 and 16 of the issuing group 10.

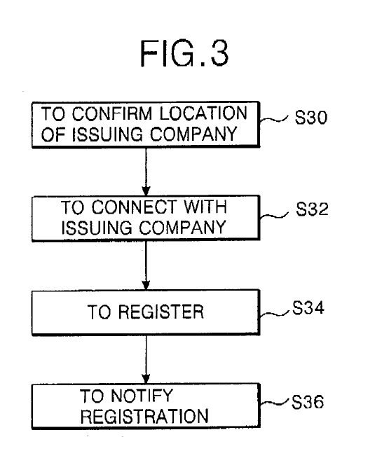

FIG. 3 illustrates a process of registering with an issuing company according to an embodiment of the present invention.

Referring to FIG. 3, firstly the user 20 makes connection with the routing server 20 to get the information on the location of the issuing company (any one of 12, 14 and 16) he desires (S30). At this moment, the user 20 makes connection with the routing server 18 in use of his terminal.

For this, the routing server 18 is stored with the location information, e.g., IP address, URL information etc, of the issuing companies 12, 14 and 16. Afterward, the user 20 makes connection with any one of the issuing companies of the issuing group 10 (S32).

Herein, it will be further described assuming that the user 20 makes connection with the second issuing company 14. The user 20 connected with the second issuing company 14 registers for membership with the second issuing company 14 (S34). At this moment, the second issuing company 14 notifies the registration information of the user 20 to the routing server 18 (S36) . The routing server 18 to which the registration information of the user 20 is notified from the second issuing company 14 encrypt and is stored with the registration information of the users 20.

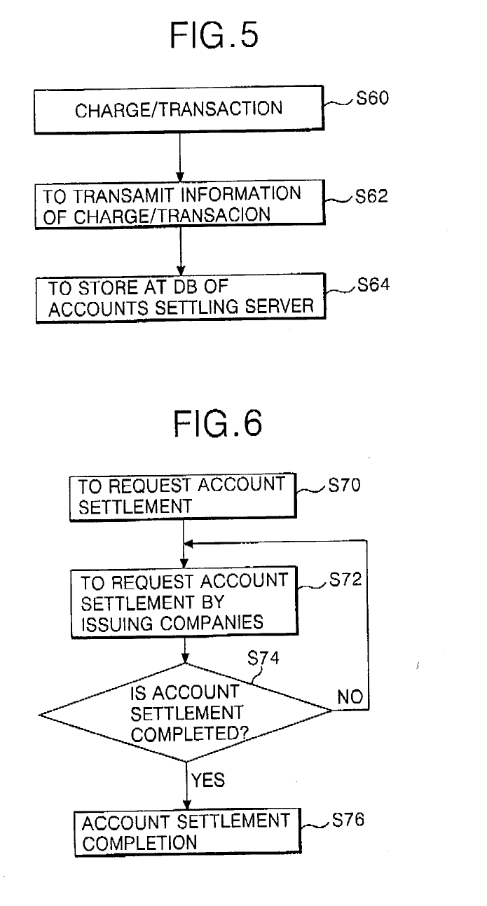

The registered user 20 as a member of the second issuing company 14 is to be given an electronic cash “B” issued from the second issuing company 14. Afterward, the user 20 loads the electronic cash “B” by going through a loading process as in FIG. 5.

FIG. 5 represents processes of loading electronic cash and transmitting transaction information according to an embodiment of the present invention.

Referring to FIG. 5, firstly the user 20 makes connection with the second issuing company 14 and remit a specified amount of money by electronic money transfer or money order etc., thereby loading the electronic cash “B” (S60). Afterward, the second issuing company 14 transmits the loading information of the user 20 to the accounts settling server 24 (S62). The accounts settling server 24 stores the loading information transmitted from the second issuing company 14 at a data base (not shown) and manages it (S64).

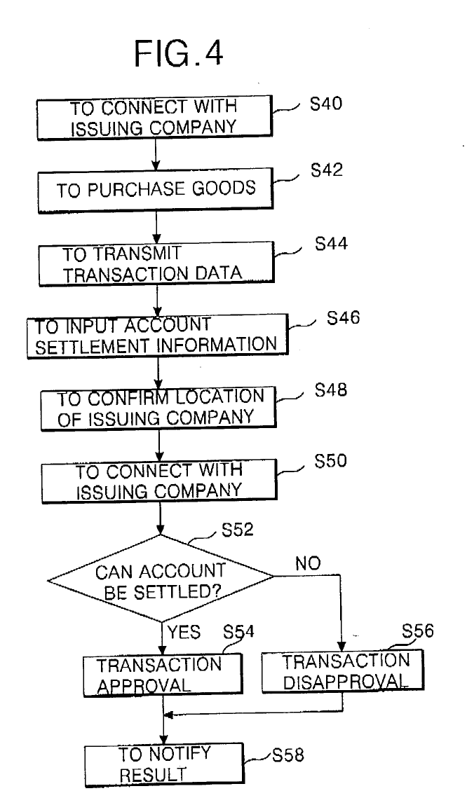

FIG. 4 illustrates a process of the user's purchasing goods.

Referring to FIG. 4, the user 20 having the electronic cash “B” issued from the second issuing company 14 makes connection to the member shop 22 (S40). The user 20 connected to the member shop 22 in the step S40 makes purchase of any one of goods offered by the member shop 22 (S42). At this moment, the member shop 22 transmits transaction data to the terminal of the user 20 (S44), wherein the transaction data includes the name and price etc of items to be purchased.

Afterward, the user 20 enter his payment information into his terminal in response to the transaction data transmitted from the member shops (S46). Herein, the user 20 enter his payment information with respect to the transaction data transmitted to his terminal, thus his information is not to be recorded and left at the member shop 22. Accordingly, it can be prevented that his information is drained out by hacking etc of a malicious purpose. If the payment information is inputted in the step S46, the terminal of the user 20 is connected to the routing server 18. The routing server 18 compares the information in the terminal of the user 20 connected thereto with the information of the users registered therewith, thus it confirms the information of the location of the issuing company 14 with which the terminal user 20 registered for membership (S48).

After confirming the location of the issuing company 14 in the step 48, the terminal of the user 20 is connected to the second issuing company 14 (S50). On the other hand, in the terminal of the user 20, it is possible to install a specific program for confirming the location of the issuing company 14 by making connection with the routing server 18 when the transaction data are inputted to the routing server 18, and making connection with the issuing company 14 whose location is confirmed through the routing server 18. The specific program like this, is to be installed by the control of the routing server 18 when there is first connection made with the routing server 18.

If the terminal of the user 20 is connected in the step S50, the second issuing company 14 checks whether the amount of money in the transaction data transmitted from the terminal of the user 20 can be settled (S52). If it is confirmed in the step S52 that the amount of money in the transaction data can be settled, the transaction is to be approved (S54) . The information approved in the step S54 is notified to the member shop 22 via the terminal of the user 20 (S58). And then, the member shop 22 delivers the purchased goods to the user 20 through a specific course.

On the other hand, if it is confirmed in the step S52 that the amount of money in the transaction data cannot be settled, the transaction will not be approved (S56). Then, the disapproval information is to be notified to the member shop 22 via the terminal of the user 20. Afterward, a message informing that the transaction is not approved is displayed on the terminal of the user 20 by the member shop 22.

According to the invention, it is not necessary for the member shop 22 to know from which issuing company 12, 14 or 16 the user's electronic cash is issued. Accordingly, the member shop 22 can accept various electronic cashes of the users 20. In other words, after the user 20 purchase the goods at the member shop, the user 20 seeks to find the issuing companies 12, 14 and 16 who are to approve the purchase of the user 20 and gets the approval therefor, thus the member shop 22 does not have to know from which issuing company the user's electronic cash is issued. Accordingly, the issuing company 22 is able to accept the electronic cashes issued from all issuing companies 12, 14 and 16 that are connected with the routing server 18.

In addition, the issuing companies 12, 14 and 16 are able to share a plurality of member shops 22 by being connected to the routing server 18.

On the other hand, the transaction information of the user 20 is transmitted to the accounts settling server 24 while going through a process in FIG. 5.

Referring back to FIG. 5, firstly the second issuing company 14 approves the transaction information transmitted from the user 20 as in the step of S54 of FIG. 4 (S60). The second issuing company 14 that approved the transaction information in the step S60 transmits the transaction information approved by itself to the accounts settling server 24 (S62). Afterward, the accounts settling server 24 stores the information transmitted from the second issuing company 14 at the data base (S64).

FIG. 6 illustrates a process of settling an account according to an embodiment of the present invention.

Referring to FIG. 6, the member shop 22 that sold the goods in use of the electronic cash requests the accounts settling server to settle the account at a specific period (or at any time) (S70). The accounts settling server 24 that received the account settling request from the member shop 22 compares the account settling information stored at itself with the account settling information requested from the member shop 22, and makes judgement on whether there is any discrepancy. At this moment, if there is any discrepancy between the account settling information stored at itself and the account settling information requested from the member shop 22, it sends to the member shop 22 a message requesting a confirmation. At this moment, it is possible to send the confirmation requesting message to the issuing company 14.

On the other hand, if the account settling information stored at the accounts settling server and the account settling information requested from the member shop 22 are the same, the account settling information is then transmitted to the corresponding issuing company 14 (S72). Afterward, the accounts settling server 24 checks whether the account settlement is completed (S74). If the account settlement is not completed in the step S74, the steps S72 and S74 are to be repeated.

If the account settlement is completed in the step S74, the information of account settlement completion is stored at the data base of the accounts settling server (S76). At the moment, the account settlement completion information is transmitted to the member shop 22. On the other hand, end-to-end connection is supported between the users 20 and the issuing group 10 in accordance with the present invention. Therefore, it is possible to assure reliability between the user 20 and the issuing group 10.

As described above, pursuant to the electronic cash sharing system and the method thereof according to the present invention, the electronic cashes issued by all issuers connected to the routing server can be used at a member shop regardless of electronic cash issuers. Specifically, the member shop sells goods in use of various electronic cashes without having to register with each of the issuers, thus it can be expected to make more profits. In other words, the user purchases the goods at the member shop, and seeks to find the issuer to get approval for the purchase of the goods, so it is not necessary for the member shop to recognize the issuer of the user's electronic cash from the issuers. Besides, when the issuer's location is changed, it is possible for the users to know the exact location of the issuers by only changing the location information stored at the routing server when the locations of the issuers are changed.

Further, this invention can assure reliability because end-to-end connection is made between the issuer and the user. In addition, the account settlement is made for the amount of money requested from the member shop in use of the account settling server in the present invention. Accordingly, the member shops don't have to make connection to each issuing company to request the account settlement.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. An electronic cash sharing system connected to the Internet through a terminal of a user for purchasing goods on the Internet in use of a specific electronic cash, the electronic cash sharing system comprising:
an issuing group having two or more issuing companies that issue electronic cashes to the user;
a routing server located between the issuing group and the terminal of the user for being stored with location information of the issuing companies of the issuing group; and
a plurality of member shops for selling goods over the Internet.

2. The electronic cash sharing system according to claim 1, wherein if goods are purchased from the member shop in use of the specific electronic cash, the user's terminal finds in the routing server the location of an issuing company that issued the specific electronic cash, makes connection with the corresponding issuing company and requests an approval for the purchase of the goods.

3. The electronic cash sharing system according to claim 2, further comprising:
an accounts settling server installed between the member shop and the issuing group for transmitting an account settling request for the purchase of the goods to the issuing company that issued the specific electronic cash used in the member shop among the issuing companies in the issuing group.

4. The electronic cash sharing system according to claim 2, wherein the electronic cashes issued from all issuing companies in the issuing group are used in the member shop.

5. The electronic cash sharing system according to claim 2, wherein the routing server is stored with the information of the users which is transmitted from all the issuing companies in the issuing group and encrypted, and providing the location of the issuing company when connected to the user's terminal in use of the user's information.

6. The electronic cash sharing system according to claim 1, wherein the routing server updates the location information if there is any change in the location information.

7. The electronic cash sharing system according to claim 6, wherein the location information includes IP (Internet Protocol) address and URL (Uniform Resource Locator).

8. A method of sharing electronic cash in sharing system including an issuing group having at least two issuing companies that issue electronic cashes, a routing server connected to the issuing companies over the Internet, and a plurality of member shops selling goods over the Internet, the method comprising steps of:
issuing a specific electronic cash when a user registers for membership with at least one issuing company among the issuing companies in the issuing group;
loading the specific electronic cash by remitting a specific amount of money to the issuing company from which the specific electronic cash is issued;
purchasing goods at the member shop in use of the specific electronic cash;
inputting a transaction information with respect to a transaction data transmitted from the member shop;
being connected to the routing server in order to confirm the location of the issuing company which issued the specific electronic cash;
being connected with the issuing company whose location is confirmed and getting approved for the transaction data; and
transmitting the information approved by the issuing company to the member shop and completing the purchase of the goods.

9. The method according to claim 8, further comprising steps of:
requesting account settlement for a sales amount made in the electronic cash from the member shop to an accounts settling server;
transmitting the account settlement information from the accounts settling server to the issuing company that issued the electronic cash;
settling the account for the amount of money in accordance with the account settlement information and transmitting an account settlement information from the issuing company to the accounts settling server; and
transmitting a message that notifies the completion of the account settlement in use of the account settlement information from the accounts settling server to the member shop.

10. The method according to claim 8, wherein the routing server updates the location information if there is any change in the location information.

11. The method according to claim 10, wherein the location information includes IP (Internet Protocol) address and URL (Uniform Resource Locator).

12. A method of sharing electronic cash in sharing system including a plurality of issuing companies that issue electronic cashes, a routing server connected to the issuing companies over the Internet, and a plurality of member shops selling goods over the Internet, the method comprising steps of:
storing location information of the issuing companies at the routing server;
issuing electronic cashes different from one another, to a plurality of users;
requesting for a purchase of goods at a member shop in use of any one of the electronic cashes issued from the issuing companies;
getting a transaction approval for the purchase of goods from the issuing company which have issued the electronic cash after the location information of the issuing companies is confirmed: and
completing the request for the purchase of goods by receiving the transaction approval information and transmitting it to the member shop.

13. The method according to claim 12, wherein in order to get the electronic cash, a user makes connection to any one of the issuing companies in use of the location information stored at the routing sever and has the electronic cash issued to oneself from the issuing company.

14. The method according to claim 13, wherein the user loads the electronic cash by remitting a specific amount of money to the issuing company from which the electronic cash is issued.

15. The method according to claim 12, wherein the user makes connection directly with the member shop in use of one's own terminal to request for a purchase of goods, receives into one's own terminal the transaction approval information corresponding to the request for the purchase of goods, gets an approval for the received transaction approval information from the issuing company, and then transmits the transaction approval information back to the member shop.

16. The method according to claim 12, wherein after the request for the purchase of goods is completed, the member shop requests an amount of money equivalent to the purchase of goods from the issuing company of the electronic cash, then the issuing company transfers the requested amount of money to the member shop.

17. The method according to claim 12, wherein the routing server updates the location information if there is any change in the location information.

18. The method according to claim 17, wherein the location information includes IP (Internet Protocol) address and URL (Uniform Resource Locator).
